(19) United States
(12) Patent Application Publication
(10) Pub. No.: US 2015/0220966 A1
(43) Pub. Date: Aug. 6, 2015

(54) RESTAURANT RESERVATION SYSTEM AND METHOD

(71) Applicants: Andrea Piana, Atlanta, GA (US); Marco Piana, New York, NY (US)

(72) Inventors: Andrea Piana, Atlanta, GA (US); Marco Piana, New York, NY (US)

(21) Appl. No.: 14/172,009

(22) Filed: Feb. 4, 2014

(51) Int. Cl. G06Q 30/02; G06Q 10/02; G06Q 50/12; G06Q 50/18

(52) U.S. Cl. CPC G06Q 30/0239; G06Q 50/188; G06Q 10/02; G06Q 50/12

(57) ABSTRACT

A mobile App enables customers and restaurants to communicate with one another to negotiate reduced costs for meals at specified reservation times when the restaurant is otherwise light for business. As an example, the App enables the customer to specify either a percentage reduction on the total bill or a budget price for the entire meal. The restaurant may either accept the offer or provide counteroffers. Once agreed upon, if the customer is a no show, the customer compensates the restaurant for operational costs in saving the table by paying a previously agreed upon penalty fee.

### FIELD OF THE INVENTION

The invention pertains to making reservations and negotiating discounts or reduced cost meal prices with restaurants using online and/or mobile application facilities.

### BACKGROUND

OpenTable® is an online reservation service where a dining entity (person or group of people) can reserve a table at a particular restaurant at a particular time. The service is national in character with featured restaurants throughout the United States and is growing internationally with restaurants participating in Toronto and London. The service identifies price ranges and provides descriptions of the types of food offerings, as well as links to some of the participating restaurant's web sites, so that a dining entity can consider whether they wish to make a reservation prior to proceeding with the reservation. Furthermore, the service allows the dining entity to search for “open tables”, e.g., restaurants that have openings and are not fully booked, across several different restaurants within a defined vicinity. In this way, a dining entity can consider, for example, all of the restaurants within a particular section of Washington D.C. that might have an opening for the dining entity on a particular day at a particular time, or all of the restaurants within the greater Washington D.C. metropolitan area that might have an opening on a particular day at a particular time, and which serve a particular style of food (e.g., Cantonese, Italian, French, etc.).

PriceLine® is an online service which enables a “buyer” (e.g., a purchaser of, e.g., airline tickets, hotel accommodations, etc.) to name a “price” (how much he or she is willing to pay for specific goods or services). “Suppliers” (e.g., an organization which supplies goods and services of the type specified by the “buyer”, e.g., airline ticketing services, hotel chains, etc.) can then agree to meet the “price” or not meet the price. The “buyer” basically guarantees the sale by inputting his or her credit card at the time he or she names the “price”, and the contract for purchase is essentially completed when a particular seller agrees to supply the goods or service at the named price. In the context of airline tickets, a buyer could indicate that he is willing to fly from New York to Atlanta for $200. Several airlines, e.g., Delta®, United®, JetBlue®, etc. or ticketing services would see the stated price. If Delta® agreed, it would basically provide the ticket to the buyer for $200, and the transaction would be finished. If no airline or ticketing service agreed, the buyer would not be issued a ticket for the price requested, and the buyer would either need to state a higher price and/or consider other options. This name your price concept also is exploited for services such as hotel rooms, cruises, etc.

Hotwire® is an online service which enables a “buyer” to book hotel reservations at reduced rates. Typically, a hotelier will reduce the rate of an unhooked hotel room close to the date of availability, and make it available through Hotwire®. The online customer can view hotel room prices at the reduced rates on Hotwire® and book the reservation at the reduced rate.

U.S. Patent Publication 2013/0090959 to Kvamme describes a restaurant reservation management system which purportedly allows restaurants to use a third party system to better manage costs, staffing and other matters related to reservations. Some of the embodiments described include allowing the would be diner to pre-pay for fixed price meals, allowing the service and/or restaurant to have dynamic pricing wherein certain time slots and or meals on certain holidays may be charged at higher prices, and allowing for the transfer of a reservation from one diner to another diner willing to pay a premium for the time slot at a particular restaurant, etc.

### SUMMARY

The invention is a system and method which enables restaurants and customers to negotiate a price or discount on a meal. In preferred embodiments, the system and method is implemented in a mobile application (App) where the customers and restaurants may use menus and buttons to make offers and counteroffers on a restaurant reservation with an agreed upon negotiated price or discount for a meal at a the reservation time with an agreed upon no show penalty.

### DESCRIPTION OF THE DRAWINGS

FIG. 1 is a schematic which shows an embodiment of the system where the negotiations between customers and restaurants takes place via network communications;

FIG. 2 is a flow diagram showing the progress of negotiations between customers and restaurants which permit customers to make reservations at specific times for discounted prices;

FIGS. 3A and 3B show exemplary screen shots for making an offer for a discount on a meal;

FIG. 4 is an exemplary screen shot pertaining to acceptance of a no-show penalty;

FIG. 5 is an exemplary screen shot pertaining to credit or debit card authorization;

FIG. 6 is an exemplary screen shot pertaining to a counter offer or acceptance of an offer which will be made by a restaurant;

FIG. 7 is an exemplary screen shot notifying the customer of acceptance of an offer (similar screen shots can be provided to the restaurant on acceptance of a counter offer from the restaurant to the customer); and

FIGS. 8A-G show examples of various screen shots for a mobile App which can be used to enhance the practice of the invention.

### DESCRIPTION

The invention provides a system and method for customers and restaurants to negotiate a discount rate or reduced price arrangement for the customer to dine at a restaurant at a given time. For purposes of this patent, a restaurant would be any establishment in the business of providing food and drink to customers at a dining location, and includes high end, privately owned and operated restaurants, chain restaurants, delicatessens, pizza shops, fast food establishments, etc. In its most preferred embodiment, the invention is employed with restaurants that take reservations and have assigned seating times, where the amount of tables in the restaurant may vary from one time period to the next. While the customers and restaurants may agree on a reservation time and day at any point in the future, the invention will have the most utility for specifying a dinner reservation within 15 minutes to 2 hours in advance, as this will enable the restaurant operator to better judge how heavy or light the walk in traffic will be for the evening so that he or she can decide whether they would want to entertain any negotiations for lower cost dinner service simply to help cover overhead costs.

Restaurants have operational costs which include the rent for the building, the cost for the chef(s) and wait staff, the cost for food inventory, insurance, power, etc. To remain viable, restaurants need to have customers visit their facility, order meals and beverages, and pay for food at a price which assures a profit. Moreover, restaurants need to enough customers visit and order enough meals or beverages so that the total amount that they collect for providing meals and beverages exceeds with operational costs and provides a healthy product. One of the unique challenges confronted by restaurants is that the inventory, i.e., the food and beverages, has a very limited shelf life. Thus, it is imperative for restaurants to sell the food and beverages as quickly as possible to reduce losses. In a number of circumstances, it would be better for restaurants to serve customers at a lower profit margin to get rid of their inventory, than to have empty tables and losses for unsold inventory and losses for operational costs attributable to the chef(s), wait staff, and power for the building, etc. However, it would be quite inconvenient in the restaurant business to dicker with the customer about price at the time they arrive at a restaurant (due to the time consuming nature of such a transaction, and the disadvantage of other patrons being able to see and hear the negotiations), and even more difficult to negotiate after a customer and his party have eaten.

This invention enables customers and restaurants to negotiate in advance a discount rate or a reduced price rate for a meal at the restaurant, as well as a penalty fee should the customer be a no show at the restaurant at the reserved time. Negotiations are performed on the fly, preferably using mobile technology (which preferably includes computer or processor functionality) such as smart phones (e.g., Android phones, Iphones, Blackberry's, etc.), but can also be performed using online communications with a computer, tablet, internet access device or other electronic interface (e.g., a wii, Xbox, or other television enabled gaming device, etc.).

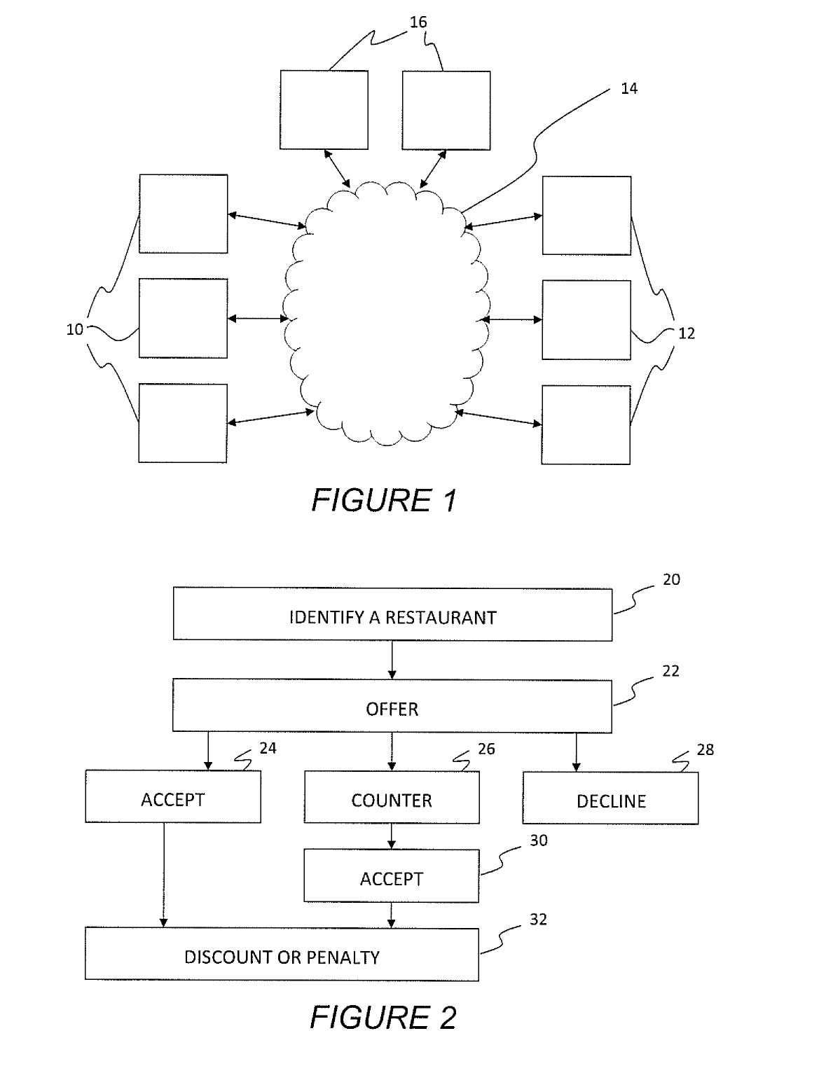

With reference to FIG. 1, in the practice of the invention, one or more customer interfaces 10 and one or more restaurant interfaces 12 communicate through a network 14 (e.g., the Internet, telephone network, radio network or other network). In the preferred embodiment, a mobile application (App) is used by both the customers and restaurants where the customers and restaurant personnel may use menus and buttons on their interfaces 10 and 12 to make offers and counteroffers on a restaurant reservation with an agreed upon negotiated price or discount for a meal at a specified reservation time with an agreed upon no show penalty. In some embodiments, a service with one or more servers 16 coordinates the process via communications though the network 14. The service might function to register a plurality of interested restaurants willing to engage in the practice of the invention. Further, consumers might also be registered through the use of the service. The service might charge a fee to each restaurant for the ability to participate. The restaurant fee might be charged for example as a one time participation fee, a monthly or annual fee, or a percentage fee on each transaction which is successfully negotiated and paid for using the inventive method and system, or a combination of the above. Other restaurant derived fees may also be possible. Similarly, the service might charge a fee when each prospective customer registers to participate. Further, the service might charge a fee for each reservation the customer secures at a discounted rate. Or the service might charge a fee that is a percentage of the savings of each reservation transaction. As with restaurant derived fees, customer derived fees can vary considerably and could include combinations of fees. While FIG. 1 illustratively depicts the servers 16 separately from the restaurant interfaces 12, it should be recognized that the service could be offered by one or more restaurants and that the servers 16 might be combined with one or more restaurant interfaces 12. For example, a chain restaurant and/or an organization that owns or controls multiple restaurants may practice the invention solely with its owned/controlled restaurants through its own network connections. In some applications, it may also be possible to merge the service with one or more customers so that the servers 16 are merged with one or more customer interfaces 10.

FIG. 2 illustrates exemplary transactions which might occur according to the inventive system and method. In step 20, a customer will identify a restaurant to which he wants to make an offer. In a mobile App context, the customer might create “favorites” lists of restaurants that are willing to participate in the practice of this inventive method (e.g., those restaurants that are registered with the service). Alternatively, the customer might use the GPS on his or her smart phone to locate participating restaurants which are within a certain radius of the customer's current position, or to locate participating restaurants which are within a certain radius of a location the customer plans to visit at, for example, dinner time. As a variation on this concept, the customer might use a GPS mapping feature to identify all participating reference within, for example, a two or five square block area of a section of a town or city. Once a group of restaurants are identified, the customer might sort through the restaurants to identify which of the restaurants are of interest to him or her. He or she might be provided with descriptions of the restaurants, menus, and possibly reviews provided by previous customers on his or her mobile phone.

Once a restaurant is identified which is of interest, the customer will make an offer to the selected restaurant at step 22. Key parts of the offer include (1) the time period for the meal, (2) the amount of people for the meal, (3) discount the customer wants, and (4) an agreement on a penalty should the offer be accepted and the customer is a no-show at the specified time.

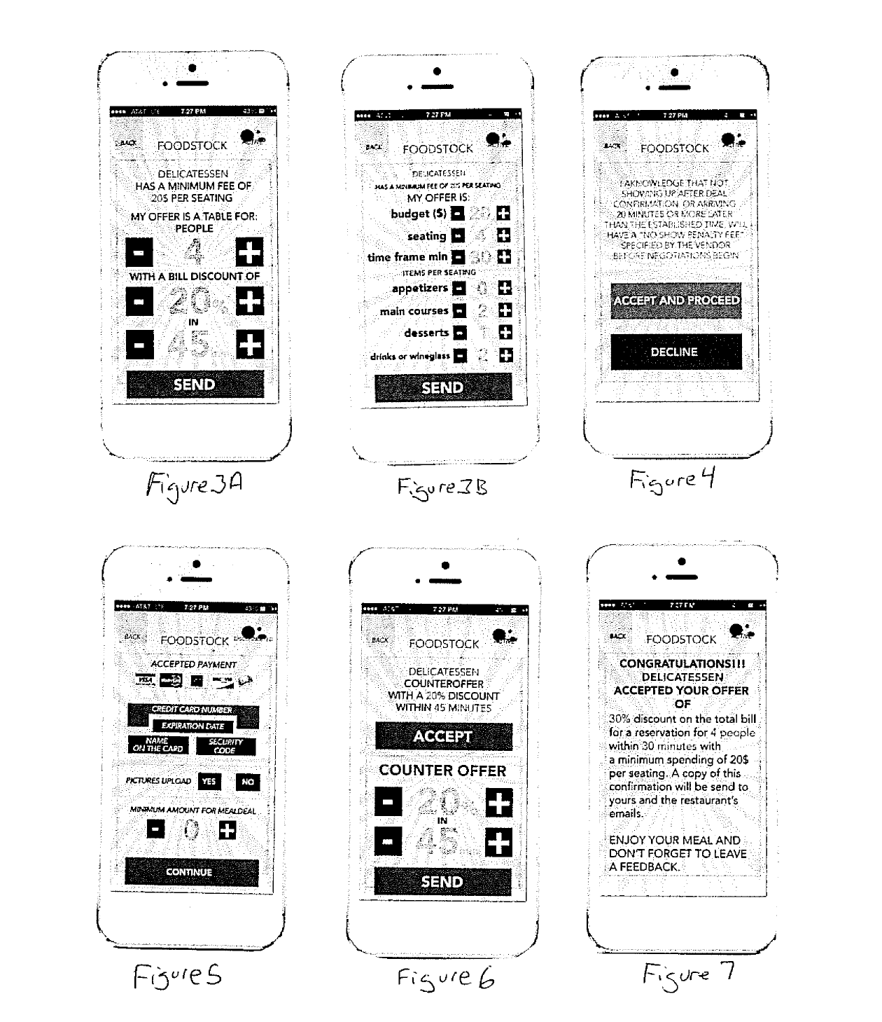

FIGS. 3A and 3B examples of the types of offers a customer might make in the practice of the invention. For example, FIG. 3A shows that a delicatessen selected by the customer will be offered a deal where the customer agrees to pay a minimum fee of $20 a person for a group of four people, if the customer can be seated in 45 minutes and the customer can be accorded a discount of 20% on his or her total bill. As can be seen from FIG. 3A, + and − buttons can be used for the customer to enter and adjust these variable. In some embodiments, it may be possible for the customer to also enter the minimum price per person per seating; however, in other embodiments, this price might be set by the restaurant itself without it being variable by the customer. Having the restaurant set a minimum price per person will have the advantage of reducing the number of offers which the restaurant might receive. A variation on the embodiment depicted in FIG. 3A would have the customer offering for a fixed amount to be deducted from the bill, e.g., an offer to have dinner for four in half an hour, so long as the bill for service is reduced by $20. As another alternative example, FIG. 3B shows that the selected delicatessen (the same as FIG. 3A where, for example, the delicatessen has a minimum fee of $20 per person) will be provided with an offer of $20 per person for four people so long as each person receives two main courses, one desert, and two drinks, and so long as the table is available in thirty minutes. For restaurants, the offer arrangement of FIG. 3B may provide them with some flexibility and control, provided that there is a limited number of main courses, deserts, and beverages to choose from. While not shown in FIG. 3B, the delicatessen might have a separate menu selection from which main courses, deserts, and beverages which qualify for a total budget offer as presented in FIG. 3B, or a specified listing of main courses, deserts, and beverages from which the customer can select from when he or she arrives at the appointed reservation time. Both FIGS. 3A and 3B show a “send” button to allow the offer to be sent to the restaurant for their consideration. Other types of offers than those illustrated in FIGS. 3A and 3B are possible within the practice of the invention.

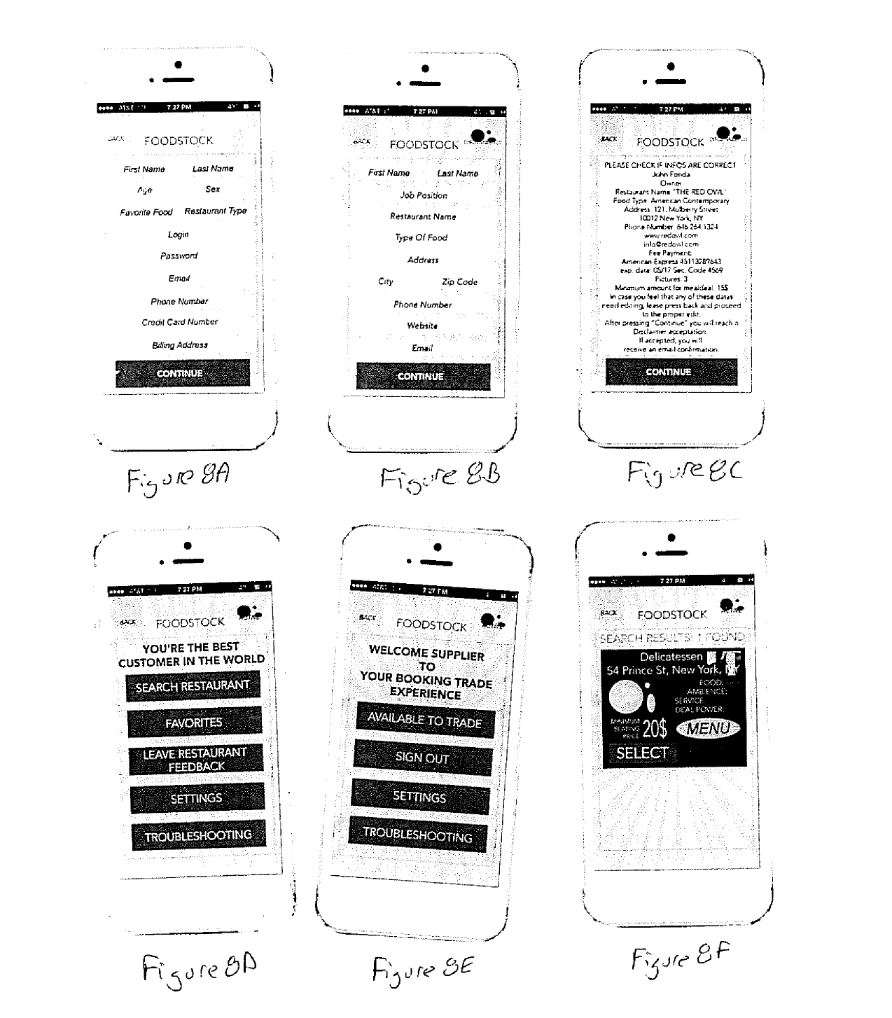

In the preferred embodiment, the customer will pay a penalty fee for a “no show”. A “no show” occurs when the customer sends out an offer as discussed in conjunction with FIGS. 2 and 3A-3B, and the restaurant accepts, or when the customer accepts a counteroffer proposed by the restaurant, and the customer, for whatever reason, never comes to the restaurant or arrives well after the agreed upon reservation time. The no show penalty could be as much as the agreed upon minimum price per person for the seating or a lower amount (e.g., an amount which will allow the restaurant to cover its operating costs for the time period when the table was held for the no show customer). FIG. 4 illustrates an embodiment of the invention whereby the customer agrees to pay a penalty fee to be assessed by the restaurant in advance of even making an offer using the system and method of this invention. For exemplary purposes, the customer agrees that if he or she does not arrive within 20 minutes after the agreed upon reservation time he or she will pay the restaurant's no show penalty fee. In FIG. 4, there is an option for the customer to decline this requirement, and, if this option is provided and the customer selects a restaurant, the restaurant could be free to make an agreement with no penalty fee. Alternatively, in embodiments where there is an option to decline, participating restaurants could have an automatic setting not to receive offers from customers that have declined. In the embodiment of FIG. 4, the time period for tardiness to the restaurant could be varied to any suitable amount of time (e.g., 15 minutes to 50 minutes). Alternatively, the amount of time that a customer could be late could vary from restaurant to restaurant. In this case, if a penalty is to be assessed, the customer might agree to the penalty as an acceptance of a counter offer with the penalty from the restaurant; rather, than operating the system and method with a pre-agreement to pay the penalty as depicted in FIG. 4. Also, the system and method could be made even more robust by having an acceptable excuse for delay provision (not shown). For example, the system and method could allow the customer that is en route to contact the restaurant by phone and indicate he or she is en route but is stuck in traffic, and the customer could send verification of this fact by sending from his or her smartphone a screen shot of a google traffic image with his or her current location and showing the traffic congestion. With a pre-agreement on an excusable delay, the restaurant may be obligated to allow for an additional 15-50 minute delay. Or, in the case of no pre-agreement, the restaurant on its own accord could send an electronic communication to the customer agreeing to hold the table for example for 15-50 minutes.

The no show penalty fee could be made as a rock solid commitment by the customer if, for example, he or she pre-registers her credit or debit card with a service with an authorization to permit a restaurant to charge against the card if the customer is a no-show and/or provides the authorization to the restaurant with the offer. Other types of commitments may also be made in the practice of the invention. FIG. 5 shows an example of a screen shot whereby the customer can pre-authorize payment using a variety of different credit cards. In some embodiments, the customer would upload his or her card information using the soft buttons on the screen. Payment services such as Paypal® may also be used. In addition to agreeing to pay the no-show penalty, the customer could authorize payment of a budget offer as discussed in conjunction with FIG. 3B. In this way, the customer would already have paid for the meal and would not need to handle a bill at the and of the meal if a budget offer is accepted.

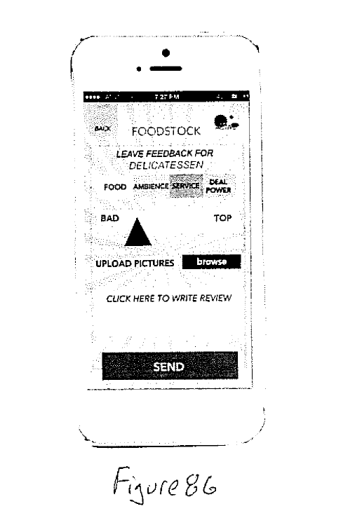

Returning to FIG. 2, after an offer is sent to a restaurant by a customer, the restaurant could accept at step 24, counter offer at step 26, or simply decline at step 28. FIG. 6 shows an example of the delicatessen discussed in conjunction with FIG. 3A, whereby the offer of 4 people at a 20% discount if they arrive in 45 minutes can be accepted by the restaurant or, by using the + and − keys the restaurant could adjust the percentage of the discount or adjust the time period for the reservation, and send a counter offer back to the customer. For example, the restaurant might agree to the 20% discount, but only if the customer and his or her party arrive in 30 minutes (prior to the arrival of a big party expected by the restaurant) or his or her party arrive in 1 hour and 10 minutes (e.g., a time when the restaurant expects a party to leave and a table to become available). Not shown in FIG. 6, the restaurant could simply not answer the offer or send an indication simply declining the offer. In either case, no reservation is made. However, in the case where the offer is accepted (e.g., by the restaurant personnel soft clicking on the “accept” button on their smartphone) or a counter offer is sent and is subsequently accepted by the customer (see step 30 in FIG. 2), a bargain, contract, or agreement is reached and the customer will be provided with a table at the specified time with services offered at the specified discount (e.g., FIG. 3A) or at the specified budget offer (e.g., FIG. 3B).

FIG. 7 shows an example of a notification which may be provided to the customer. For example, the notification will tell the customer of the discount agreement reached, the time period for the reservation, the minimum cost per person (if any), and in some embodiments will will request feedback from the customer after the meal. When an agreement for the negotiated discount, a service might provide, for example, e-mail confirmations to both the customer and the restaurant for their records and for easy retrieval and review.

FIG. 2 shows the customer being able to accept a counter offer at step 30. If desired, in some embodiments, the customer might also be able to counter the counter offer, with the restaurant being able to accept or counter again. The number of iterations can vary depending on how the App is set up and/or can vary depending on pre-programmed settings for either or both the customer and the restaurant. After acceptance, the agreement between the customer is reached and at step 32 the discount will be applied when the customer and his or her party finish their meal (e.g., the FIG. 3A example), the budgeted amount will be applied when the customer and his party finishes the meal (e.g., the FIG. 3B example with, in some cases, the customer not needing to take any further action at the restaurant to effect payment (as discussed above), or the penalty will be applied if the customer is a no show (e.g., he does not show up or arrives way to late—in which case there may be no agreement on a discount absent further agreement by the restaurant).

The above assumes that after a deal is agreed to, the customer will be provided a meal at a discount at a specified time or the customer will pay a no show fee. However, it is possible that some participating restaurants would, absent some penalty renig on the deal by giving away discount table to other patrons if for example the restaurant suddenly became busy right after the restaurant accepted an offer or the customer accepted a counter offer. In some embodiments, these situations may be handled by the restaurant registering a credit card, debit card, Paypal® or other money transferring vehicle with the service so that the customer can redeem a penalty for renigging on a deal. This penalty fee could be negotiated during the transaction as discussed above for the customer's penalty fee, or could simply be a fee agreed to by the restaurant when it registers with the service. Thus, if a customer shows up on time and no table is available for him or her, they can notify the service to redeem the penalty fee from the restaurant. The fee could be quite variable and for example could be a flat $50-5100 fee per arrangement which the restaurant canceled, or could be a per person in the party fee of for example $50-$100, e.g., if a customer arranges for a deal for a seating of four and the restaurant renigs then, the customer would be entity to $200-$400 for the cancellation of the contract.

FIGS. 8A-8G show further examples of screen shots which may be used to enhance the system and method of the invention, particularly in the form of a mobile App. For example, FIGS. 8A-8B show screen shots which might be used by a customer and a restaurant employee to enter descriptive information (such as for registration with a service, etc.). For example, with reference to FIG. 8A, the customer might enter his or name, a login, password, e-mail, phone number, credit card number and other descriptive information, and with reference to FIG. 8B, a restaurant employee that has authority to bind the restaurant might enter in their name, job position, address, phone number, e-mail, web site and other descriptive information. In some embodiments, the customer might also enter in their favorite foods and restaurant types (see FIG. 8A) and the restaurant employee might enter in the type of food they serve and/or have a link to their menu or other descriptive material. FIG. 8C shows a screen shot that might be provided to a restaurant employee in order for them to confirm their information. In FIG. 8C, the restaurant name, address, and the owner is identified, along with for example, the types of credit cards they will accept, and (as discussed above) a minimum amount they will accept per person on any negotiated meal service. FIG. 8D shows an example of a general purpose screen where, for example, a customer can conduct searches for restaurants, elect to scroll through a favorites listing, change or adjust settings, engage in trouble shooting, and elect to provide feedback on a restaurant. For a mobile App it is advantageous for an operator (customer or restaurant employee) to be able to walk through the operations with as little keying as possible. FIG. 8D shows a menu arrangement which permits the customer to easily go from one step to another, and it will be recognized that a wide variety of variations on this theme are possible. FIG. 8E shows an example of a screen shot which might be used by a restaurant employee. Similar to FIG. 8D, buttons may be provided for getting to areas of the program (system) which allow adjusting settings and trouble shooting. FIG. 8E also illustrates a particular embodiment whereby a restaurant can provide an indication of whether it is available to trade (i.e., willing to accept offers on reduced price paying tables). If the registered restaurant is full for the evening, or is closed, or for other reasons does not wish to entertain offers, the restaurant can notify customers by operating the available to trade feature. In a preferred embodiment, customers searching for a restaurant will see an indication on their smartphone or tablet or computer that indicates that the restaurant is or is not willing to accept offers. For example, an icon, such as shown in the top right corner of the screen shot, can have a color or shape indicative of the restaurants ability to trade. This icon will be presented, for example, on a customer's smartphone when the customer identifies a restaurant he or she wishes to dine at. For example, with reference to FIG. 8F, the same icon is presented to the customer in the top right corner of the screen when he or she has located a delicatessen (or other restaurant) they wish to dine at through either a search or a scan of their favorites. Alternatively, as also depicted in FIG. 8F, the ability to make deals may simply be indicated by a text entry such as “RTisOFF”. FIG. 8F is an example of a screen which would enable a customer to learn something about a restaurant before making an offer. For example, in addition to the name, type of food and address, the customer might be able to be presented with information on the ambience and service or the customers deal making power with this restaurant (as might all be ascertained from feedback of other customers that dined at the restaurant). FIG. 8F shows that the customer might also be provided with information such as what the minimum seating price for the restaurant is, and may include a link which allows the customer to peruse the menu of the restaurant. In addition, FIG. 8F shows that the customer may be provided with a button enabling the customer to select the restaurant for making a discount offer. FIG. 8G shows that the customer may be able to provide simple feedback information on a restaurant after having dined at the restaurant using, for example, his or her smartphone. This might be accomplished by having buttons to click for rating the food, the ambience, the cleanlines, the ability to negotiate a reduced price, etc., with various ratings being selectable using soft key buttons. Alternatively or in addition, the customer may use a screen to type in comments concerning the restaurant. This information would be made available to other customers through the network, and may be able to be reviewed when conducting a search, such as, for example, when at the search screen shown in FIG. 8F.

The system and method of the invention may also be made robust by permitting the customer to present several offers to several restaurants simultaneously. In this embodiment, for example, once a restaurant has accepted the offer or once the customer has accepted a counter offer made by a restaurant, all outstanding offers will be automatically terminated. This type of operation might best be implemented using a service as discussed above in conjunction with FIG. 1 wherein the service will be able to track the outstanding offers and recognize when an agreement between a restaurant and a customer has been reached. A variation on this concept could be an option for the customer simultaneously sending an offer to each and every participating restaurant that is accepting offers within, for example a 2 to 5 block distance from a site of interest (e.g. a theater, a sporting location such as Madison Square Garden, etc.).

Furthermore features of the system and method can be enhanced in a variety of ways. For example, the restaurant search feature might include options to only search for Cantonese or Italian restaurants within a certain area of a town or city, or to search for only Zagat® rated restaurants, or to search for family friendly restaurants, or to search for restaurants which permit dogs to sit in outside seating areas, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In particular, with reference to FIG. 1, the program App may be obtained from the servers 16 of a service provider by both customers and restaurants downloading the App to their interfaces 10 and 12, e.g., smartphones, tablets, etc. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in terms of its preferred and alternative embodiments, those of skill in the art will recognize that the system and method may be practiced with modification within the spirit and scope of the appended claims.

1. A computer implemented method for enabling negotiations between a customer and a restaurant to make reservations for a meal to be provided at a discount, comprising the steps of:
providing from a customer interface to a restaurant interface through a network a proposal for said customer to dine at said restaurant at a specified time for a specified discount;
providing from said restaurant interface to said customer interface through said network either an acceptance of said proposal or a counteroffer to said proposal; and
permitting said customer and said restaurant to agree to said proposal or said counteroffer using either said customer interface or said restaurant interface, said permitting step securing a reservation time for said customer at said restaurant at an agreed time for an agreed discount.

2. The computer implemented method of claim 1 wherein either or both said providing steps specify a penalty for a no show by said customer for said reservation time, and wherein said permitting step secures an agreement to an agreed penalty.

3. The computer implemented method of claim 2 further comprising the step of permitting said customer to guarantee payment of said agreed penalty.

4. The computer implemented method of claim 1 wherein said agreed discount specifies a percentage reduction for a cost of a meal.

5. The computer implemented method of claim 1 wherein said agreed discount specifies a specific amount reduction for a cost of a meal.

6. The computer implemented method of claim 1 wherein said agreed discount specifies a specific amount for a total bill for specified menu items or categories of menu items.

7. The computer implemented method of claim 6 further comprising the step of permitting said customer to prepay said specific amount.

8. The computer implemented method of claim 1 further comprising the steps of
enabling a customer to search for restaurants using said customer interface; and
enabling a customer to select one or more restaurants using said customer interface.

9. The computer implemented method of claim 8 wherein said step of providing from said customer interface to said restaurant interface through a network said proposal is performed multiple times for each of a plurality of restaurants, and further comprising the step of revoking, canceling or withdrawing one or more proposals upon acceptance of a proposal by one of said plurality of restaurants.

10. The computer implemented of claim 8 further comprising the step of notifying a customer on said customer interface when said customer is searching for restaurants whether or not a restaurant will consider proposals for a reservation at said specified time.

11. The computer implemented method of claim 1 further comprising the step of providing from said customer interface to said network feedback information on said restaurant.

12. A computer program product for enabling negotiations between a customer and a restaurant to make reservations for a meal to be provided at a discount, said computer program product comprising a computer readable storage medium having program instructions embodied therewith, said program instructions executable by a processor to perform the steps comprising of:
providing from a customer interface to a restaurant interface through a network a proposal for said customer to dine at said restaurant at a specified time for a specified discount;
providing from said restaurant interface to said customer interface through said network either an acceptance of said proposal or a counteroffer to said proposal; and
permitting said customer and said restaurant to agree to said proposal or said counteroffer using either said customer interface or said restaurant interface, said permitting step securing a reservation time for said customer at said restaurant at an agreed time for an agreed discount.

13. The computer program product of claim 12 wherein either or both said providing steps specify a penalty for a no show by said customer for said reservation time, and wherein said permitting step secures an agreement to an agreed penalty.

14. The computer program product of claim 13 wherein said program instructions executable by said processor enable performing the step of permitting said customer to guarantee payment of said agreed penalty.

15. The computer program product of claim 12 wherein said agreed discount either specifies a percentage reduction for a cost of a meal or a specific amount reduction for said cost of said meal.

16. The computer program product of claim 12 wherein said agreed discount specifies a specific amount for a total bill for specified menu items or categories of menu items.

17. The computer program product of claim 16 wherein said program instructions executable by said processor enable performing the step of permitting said customer to pre-pay said specific amount.

18. The computer program product of claim 12 wherein said program instructions executable by said processor enable performing the steps of:
enabling a customer to search for restaurants using said customer interface; and
enabling a customer to select one or more restaurants using said customer interface.

19. The computer program product of claim 18 wherein said step of providing from said customer interface to said restaurant interface through a network said proposal is performed multiple times for each of a plurality of restaurants, and
wherein said program instructions executable by said processor enable the step of revoking, canceling or withdrawing one or more proposals upon acceptance of a proposal by one of said plurality of restaurants.

20. The computer program product of claim 18 wherein said program instructions executable by said processor enable the step of notifying a customer on said customer interface when said customer is searching for restaurants whether or not a restaurant will consider proposals for a reservation at said specified time.
